(19) United States
(12) Patent Application Publication
(10) Pub. No.: US 2015/0240068 A1
(43) Pub. Date: Aug. 27, 2015

(54) CURABLE EPOXY RESIN COMPOSITION

(71) Applicants: Lei Yan, (US); Yi Zhang, (US); Wei Zhou, (US)

(72) Inventors: Zhaohui Yan, Shanghai (CN); Yi Zhang, Wichita, KS (US); Wei Zhou, Shanghai (CN)

(73) Assignees: Dow Chemical (China) Investment Company Limited, Shanghai (CN); The Dow Chemical Company, Midland, MI (US)

(21) Appl. No.: 14/422,601

(22) PCT Filed: Oct. 31, 2012
(86) PCT No.: PCT/CN2012/083844

§ 371 Date: Feb. 19, 2015

(51) Int. Cl. C08L 63/00; C09D 163/00

(52) U.S. Cl. CPC C08L 63/00; C09D 163/00

(57) ABSTRACT

A curing agent composition for an epoxy compound including (a) at least one phenalkamine, and (b) at least one isocyanate; a curable composition including (I) at least one epoxy compound, (II) at least one phenalkamine, and (III) at least one isocyanate; and a thermoset prepared from the above curable composition.

### FIELD

The present invention is related to a curing agent composition for epoxy resins including a combination of at least one modified cashew nutshell liquid hardener or the phenalkamine and an isocyanate; to a curable epoxy resin composition or formulation including the curing agent composition; and to a thermoset prepared from the curable composition or formulation.

### BACKGROUND

Epoxide compounds are known to be used with a curing agent and other additives to form a curable formulation or composition which can subsequently be cured to form a cured product or thermoset. The thermoset, in turn, can be used in various applications. For example, industrial maintenance and civil engineering industries require epoxy resin systems with good flexibility, good adhesion, rapid cure and good chemical resistance.

Modified cashew nutshell liquid hardener or a phenalkamine is the condensation product of cashew nutshell liquid (CNSL), formaldehyde and polyamines. CNSL is abstracted from the honeycomb structure of cashew nutshell; CNSL contains typically 70% anacardic acid, 18% cardol, and 5% cardanol. By thermally treating the CNSL by decarboxylization and followed by distillation, anacardic acid is converted to cardanol.

Phenalkamines have been widely used in marine and protective coatings as the curing agent in epoxy systems. For example, Canadian Patent No. 1082229 describes a composition and process for preparing phenalkamines and the use of phenalkamines as a curing agent for epoxy resins. As curing agents for epoxy resins, phenalkamines are moisture insensitive and enable curing even underwater. The phenolic functionality serves the purpose of phenolic accelerators allowing a fast cure. However, as known in the industry, a phenalkamine used alone as a curing agent will bring brittleness to epoxy resin systems; CA 1082229 does not solve the brittleness.

Phenalkamines provide several benefits including, for example, (i) rapid cure within a workable pot life, which is comparable to many aliphatic amines, (ii) good chemical resistance, such as for example passing a 4000 hour salt spray test; (iii) low temperature cure capabilities such as curing at temperatures as low as −5° C.; and (iv) increased hydrophobicity due to its long alkyl side chain. However, the fast curability of phenalkamine-enabled systems have an impact on cross-linked networks resulting in a loss of flexibility and adhesion; and revealing a common tradeoff between flexibility and cure speed. Blending curing agents like polyamidoamines or polyetheramines could enhance the flexibility of epoxy systems but these known curing agents significantly reduce curing speed to longer than 12 hours. The addition of accelerators into a curing agent composition increases cross-link density in an epoxy resin accompanied with increased hardness and chemical resistance. However, addition of accelerators will lead to a thermoset product with brittleness.

Another tradeoff in an epoxy resin composition is for example between flexibility and chemical resistance. A polydiglycidylether type of flexibilizer used in an epoxy resin composition provides chain segments with greater free rotation in the backbone. However, the polydiglycidylether type of flexibilizer exhibits some disadvantages such as reduced chemical resistance and reduced water resistance. Similarly, flexible systems including polyamidoamines or polyetheramines used in an epoxy resin composition do not provide a thermoset product with satisfactory chemical resistance.

### SUMMARY

The present invention provides the epoxy industry with an epoxy resin system or epoxy curable composition which can be used to prepare thermoset resin products having a balanced set of properties such as performance properties in terms of flexibility and adhesion, fast curing within a workable pot life and chemical resistance; and wherein the thermoset resin products can be used in a wide range of various applications and enduses.

The present invention is directed to a curing agent composition including a synergistic combination of a phenalkamine and an isocyanate which provides the combination of good flexibility and adhesion, good chemical resistance and fast curing. The present invention can be used in protective coating, civil engineering, and water infrastructures industries.

Furthermore, the present invention relates to a novel synergistic combination of isocyanate and phenalkamine and use of such combinations to improve the physical properties of cured epoxy resins. In the present invention, the novel combination of phenalkamine and isocyanate meets the requirements for balancing the properties of a cured epoxy resin. For example, in the present invention, a combination of a phenalkamine and an isocyanate is used to flexibilize an epoxy resin. In the present invention the isocyanate is used to toughen the epoxy resin enabled by phenalkamines.

For example, one embodiment of the present invention is directed to a novel curing agent composition for epoxy resins, wherein the curing agent composition includes (a) at least one phenalkamine and (b) at least one isocyanate.

Another embodiment of the present invention is directed to a curable epoxy resin composition including (I) at least one epoxy compound; and (II) at least one phenalkamine and (III) at least one isocyanate.

Still another embodiment of the present invention is directed to a thermoset prepared from the above curable composition.

Some of the advantages provided by the present invention include an overall good performance of epoxy systems in terms of curing speed, flexibility, adhesion, and chemical resistance is achieved. The brittleness versus fast dry and flexibility versus chemical resistance trade-offs are able to be balanced by the present invention.

### DETAILED DESCRIPTION

“Rapid cure” herein means the resin system can form a crosslinked network and reach final properties at room temperature and elevated temperatures, respectively, within relatively short time period.

“A workable pot life” herein means that the epoxy resin system has the storage stability at room temperature and elevated temperatures, respectively, allowing manual or mechanical application.

“Chemical resistance” herein means that the resin system's resistance to the effect of liquids other than water.

“Flexibility” herein means the ability of an epoxy resin system to deform without failure and the resistance to impact.

“Adhesion” herein means the ability of an epoxy resin system to bond to an applied surface.

Test methods indicated herein refer to the most recent test method as of the priority date of this document when a date is not indicated with the test method number. References to test methods contain both a reference to the testing society and the test method number. For example, the following test method abbreviations and identifiers apply herein: ASTM refers to ASTM International.

“And/or” means “and, or as an alternative”. All ranges include endpoints unless otherwise indicated.

One embodiment of the present invention is directed to providing a curing agent formulation or composition including (a) at least one phenalkamine; and (b) at least one isocyanate to form a curing agent composition which can then be used to cure an epoxy resin. Other optional additives known to the skilled artisan can be included in the curing agent composition such as for example an accelerator or a catalyst and other additives for various enduse applications.

The preparation of modified cashew nutshell liquid (CNSL) hardener essentially employs distilled cashew nutshell liquid (which is commercially available, for example, from Huada Saigao [Yantai] Science & Technology Company Limited), formalin or paraformaldehyde; and an aliphatic polyamine precursor, a polyoxyalkylene precusor, a cycloaliphatic polyamine precursor, an aromatic polyamine precursor, or a mixture thereof Examples of the aliphatic polyamine precursor may include ethylenediamine (EDA), diethylenetriamine (DETA), triethylenetetramine (TETA), tetraethylenepentamine (TEPA), pentaethylenehexamine (PEHA), N-aminoethylpiperazine (N-AEP), and mixtures thereof. The polyoxyalkylene precursor may include for example Jeffamine® D-230 and Jeffamine® D-400 which are commercially available from Huntsman Corporation. Examples of the cycloaliphatic polyamine precursor may include isophorone diamine (IPDA), 1,3-cyclohexanebis(methylamine) (1,3-BAC), 4,4′-methylenebis(cyclohexylamine) (PACM), and mixtures thereof. The aromatic polyamine precursor may include for example m-xylylenediamine (MXDA).

Benzene or xylene can be optionally used in the present invention process acting as a solvent to remove water produced during the reaction at the azeotropic distillation point.

The initial molar ratio for the modified cashew nutshell liquid hardener synthesis can vary in the range of CNSL:aldehyde:polyamine can be for example 1.0:1.0-3.0:1.0-3.0 in one embodiment, and 1.0:2.0-2.4:2.0-2.2 in another embodiment.

A preferred embodiment of the present invention includes for example a phenalkamine compound defined by Structure (I) as follows:

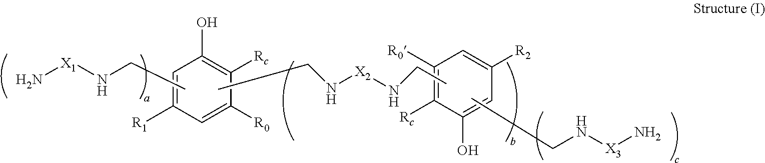

The modified cashew nutshell liquid (CNSL) hardener, or phenalkamine, has a general structure described above with reference to Structure (I). CNSL used in synthesizing phenalkamine can be of any grade of distillation (that is, the anacardic acid residue or the cardanol proportion is not necessarily specified) depending on the desire of corrosion resistance level of the cured article. For industrial utility, the residue anacardic acid in the distillated CNSL used to produce phenalkamine is generally less than (<) 20%, preferably <10%, and more preferably <5% to achieve better corrosion-resistance performance. In Structure (I), R₀ and R_{0′} each can be a straight alkyl with 15 carbons and 0 to 3 C═C bond(s) such as for example —C₁₅H₃₁, —C₁₅H₂₉, —C₁₅H₂₇, or —C₁₅H₂₅, or a straight alkyl with 17 carbons and 1 to 3 C═C bond(s) such as for example —C₁₇H₃₃, —C₁₇H₃₁, or —C₁₇H₂₉; R₁ and R₂ each can be hydrogen (—H) or hydroxyl (—OH); R_{c} can be hydrogen (—H) or carboxyl (—COOH); a can be 0 to 2; b can be 0 or a natural number less than or equal to (≦) 20; c can be 0 or 1; wherein a+b+c≠0; X₁, X₂, and X₃ each can be a bivalent or multivalent group having an ethylene aliphatic (—(CH₂)ₙ—), amino ethylene (—(NH(CH₂)m)n-), polyoxyalkylene, cycloaliphatic

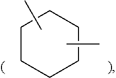

aromatic

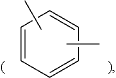

polycyclic

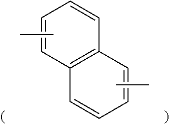

structure; and the like.

Alkyl phenols for example nonyl phenol and octyl phenol are difficult to biodegrade and are now strictly controlled due to the risk of the leakage to the environment. CNSL, a natural and renewable resource abstracted from cashew nutshell, is readily biodegradable (for example, 96% after 28 days when tested using OECD Method 302D, as referenced in a report found at the following website: www.epa.gov/hpv/pubs/summaries/casntliq/c13793tp.pdf of the U.S. Environmental Protection Agency); and can benefit epoxy resin applications that are exposed to the environment.

Isocyanate can be isocyanate terminated urethane prepolymer and blocked isocyanate terminated urethane prepolymer.

For the purpose of the present invention, hydroxy compounds that can be used to produce an isocyanate group-terminated urethane prepolymer may include di- or polyvalent polyetherpolyols, polyesterpolyols, castor oil derivatives, toll oil derivatives, and mixtures thereof Polyols having a molecular weight between about 500 and about 8,000 may preferably be used. Suitable diisocyanates or polyisocyanates useful for preparing the prepolymer include aliphatic, cycloaliphatic, aromatic, or heterocyclic organic diisocyanates and polyisocyanates having at least two isocyanate groups, and mixtures thereof. An isocyanate group-terminated urethane prepolymer may be prepared for the purpose of the present invention by combining one, or more than one, of the above listed hydroxy compounds and an isocyanate compound.

The blocked isocyanate compound useful as component in preparing a curing agent composition of the present invention may comprise, for example, any blocked isocyanate compound known in the art. Preferably, for example, the blocked isocyanate compounds can be selected from compounds having carbamic acid aryl ester groups which can be linear or branched, preferably obtained by reacting polymerization or polycondensation products containing isocyanate groups (isocyanate prepolymers) with phenol or phenol derivatives or phenolic group-containing hydrocarbon resin or any combination thereof. The isocyanate compound can be selected from toluene diisocyanate, methylene diphenyl, diisocyanate, hexane diisocyanate, isophorone diisocyanate and mixtures thereof. In one preferred embodiment, toluene diisocyanate and isophorone diisocyanate may preferably be used. Blocking agents of NCO groups include compounds which contain hydroxyl groups, for example, phenol, substituted phenols, phenolic OH group-containing hydrocarbon resins. Suitable blocked isocyanates useful in the present invention include for example the blocked isocyanates described in GB1399257 and U.S. Pat. No. 6,060,574.

Preferably, the blocked isocyanate compound useful in the present invention may be selected from commercially available products such as for example Desmocap 11 and Desmocap 12 commercially available from Bayer; and BI7770, or BI7771, BI7774 and BI7779 commercially available from Baxenden.

Generally, the ratio of isocyanate to epoxy resin may range from about 3:97 to about 90:10 in one embodiment, from about 5:95 to about 50:50 in another embodiment; and from about 7.5:92.5 to about 30:70 in still another embodiment.

The present invention curing agent composition may include optional additives known to the skilled artisan that are not detrimental to the curing agent composition. For example, the curing agent composition can include an accelerator or a catalyst or other additives required for various enduse applications.

The concentration of any one of the above described optional components when used in the curing agent composition of the present invention may range generally from about 0 weight percent (wt %) to about 60 wt % in one embodiment, from about 0.1 wt % to about 40 wt % in another embodiment, from about 0.15 wt % to about 20 wt % in still another embodiment, and from about 0.5 wt % to about 10 wt % in yet another embodiment, based on the weight of the curable composition.

The process for preparing the curing agent composition of the present invention includes admixing (a) at least one phenalkamine compound; and (b) at least one isocyanate compound to form a curing agent composition which can then be used to cure an epoxy resin. Optionally, other optional ingredients are added to the curing agent composition mixture as needed. For example, the preparation of the curing agent formulation of the present invention is achieved by blending, in known mixing equipment, the phenalkamine compound, the isocyanate compound, and optionally any other desirable additives. Any of the above-mentioned optional additives may be added to the composition during the mixing or prior to the mixing to form the curing agent composition.

All the compounds of the curing agent composition are typically mixed and dispersed at a temperature enabling the preparation of an effective curing agent composition having the desired balance of properties for a particular application. For example, the temperature during the mixing of all components may be generally from about 5° C. to about 200° C. in one embodiment, and from about 10° C. to about 50° C. in another embodiment.

The preparation of the curing agent composition of the present invention, and/or any of the steps thereof, may be a batch or a continuous process. The mixing equipment used in the process may be any vessel and ancillary equipment well known to those skilled in the art.

Another embodiment of the present invention is directed to providing a curable resin formulation or composition including (I) at least one epoxide compound; and (II) at least one amine curing agent composition as described above. Other optional additives known to the skilled artisan can be included in the curable composition such as for example a curing catalyst and other additives for various enduse applications.

Epoxy compounds, component (I), useful in the present invention include a wide variety of epoxy compounds. For example, the curable composition of the present invention may include at least one epoxy resin compound such as a liquid epoxy resin (LER) component (I) to form the epoxy matrix in a final thermoset product made from the curable formulation. For example, the epoxide compound useful as component (I) in preparing a curable composition of the present invention may comprise, a low viscosity liquid epoxy resin compound. For example, the low viscosity epoxy resin compound useful in the present invention may include the divinylarene dioxide epoxy compounds described in U.S. Patent Application Publication No. 2011/0245434, incorporated herein by reference.

Polyepoxides, as the epoxy resin compound useful in the present invention, can be aliphatic, cycloaliphatic, aromatic, hetero-cyclic or mixtures thereof. Desirably, epoxy compounds contain, on the average, one or more reactive oxirane groups. Epoxy resins useful in embodiments may include mono-functional epoxy resins, multi- or poly-functional epoxy resins, and combinations thereof.

One embodiment of the epoxy compound used in the curable composition of the present invention may be, for example, a single epoxy compound used alone; or a combination of two or more epoxy compounds known in the art such as any of the epoxy compounds described, for example, in Lee, H. and Neville, K., Handbook of Epoxy Resins, McGraw-Hill Book Company, New York, 1967, Chapter 2, pages 2-1 to 2-27, incorporated herein by reference. The preparation of the epoxy resins useful in the present invention is also disclosed, for example, in the above Lee, H. and Neville, K., Handbook of Epoxy Resins, reference.

In one preferred embodiment, the epoxy compound may include for example epoxy resins based on reaction products of polyfunctional alcohols, phenols, cycloaliphatic carboxylic acids, aromatic amines, or aminophenols with epichlorohydrin. A few non-limiting embodiments of the epoxy compound include, for example, bisphenol A diglycidyl ether, bisphenol F diglycidyl ether, resorcinol diglycidyl ether, triglycidyl ethers of para-aminophenols, and mixtures thereof. Other suitable epoxy resins known in the art include for example reaction products of epichlorohydrin with o-cresol novolacs, hydrocarbon novolacs, phenol novolacs, and mixtures thereof. The epoxy compound may also be selected from commercially available epoxy resin products such as for example, D.E.R.® 331, D.E.R.332, D.E.R. 354, D.E.R. 580, D.E.R. 671, D.E.R. 852 D.E.N.® 425, D.E.N. 431, D.E.N. 438, D.E.R. 736, or D.E.R. 732 epoxy resins available from The Dow Chemical Company, or mixtures thereof.

Generally, the amount of other epoxy compound used in the curable composition of the present invention may be in the range of from about 10 wt % to about 95 wt % in the final composition containing epoxy resin, isocyanate and phenalkamine one embodiment, from about 20 wt % to about 90 wt % in another embodiment; and from about 30 wt % to about 85 wt % in still another embodiment.

Generally, the phenalkamine hardener can be incorporated at a level to provide from about 0.5 to about 1.5 equivalents active amine hydrogen atoms per equivalent of the resin forming components in one embodiment; and preferably, from about 0.9 to about 1.1 equivalents active amine hydrogen atoms per equivalent of the resin forming components.

Phenalkamine compounds, component (II), useful in the present invention include any one or more of the phenalkamine compounds described above. For example, in one embodiment, the phenalkamine compound used in the curable composition of the present invention includes a phenalkamine compound defined by Structure (I) as follows:

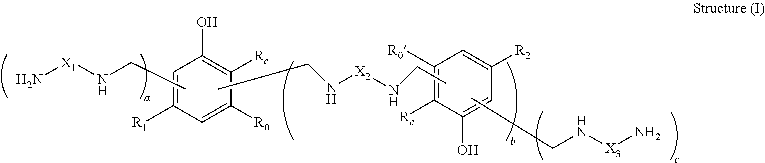

The modified CNSL hardener, or phenalkamine, has a general structure described above with reference to Structure (I). CNSL used in synthesizing phenalkamine can be of any grade of distillation (that is, wherein the anacardic acid residue or the cardanol proportion is not necessarily specified) depending on the desire of corrosion resistance level of the cured article. For industrial utility, the residue anacardic acid in the distillated CNSL used to produce phenalkamine is generally about <20%, preferably about <10%, and more preferably about <5% achieve better corrosion-resistance performance. In Structure (I), R₀ and R_{0′} each can be a straight alkyl with 15 carbons and 0 to 3 C═C bond(s) such as for example —C₁₅H₃₁, —C₁₅H₂₉, —C₁₅H₂₇, or —C₁₅H₂₅, or a straight alkyl with 17 carbons and 1 to 3 C═C bond(s) such as for example —C₁₇H₃₃, —C₁₇H₃₁, or —C₁₇H₂₉; R₁ and R₂ each can be hydrogen (—H) or hydroxyl (—OH); R_{c} can be hydrogen (—H) or carboxyl (—COOH); a can be 0 to 2; b can be 0 or a natural number ≦20; c can be 0 or 1; wherein a+b+c≠0; X₁, X₂, and X₃ each can be a bivalent or multivalent group having an ethylene aliphatic (—(CH₂)ₙ—), amino ethylene (—(NH(CH₂)m)n-), polyoxyalkylene, cycloaliphatic

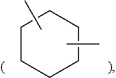

aromatic

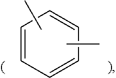

polycyclic

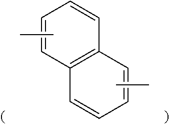

structure; and the like.

The isocyanate compound useful as component (III) in preparing a curable composition of the present invention may comprise, for example, any one or more of the isocyanate compounds described above. For example, in one embodiment, the isocyanate compound used in the curable resin composition of the present invention includes a blocked isocyanate compound can be selected from compounds having carbamic acid aryl ester groups which can be linear or branched, preferably obtained by reacting polymerization or polycondensation products containing isocyanate groups (isocyanate prepolymers) with phenol or phenol derivatives or phenolic group-containing hydrocarbon resin as described above.

Other optional compounds that may be added to the curable resin composition of the present invention may include compounds that are normally used in resin formulations known to those skilled in the art for preparing curable compositions and thermosets. Other optional components that can be added to the curable composition may comprise compounds that can be added to the composition to enhance application properties (for example, surface tension modifiers or flow aids), reliability properties (for example, adhesion promoters) the reaction rate, the selectivity of the reaction, and/or the catalyst lifetime.

Other optional compounds that may be added to the curable composition of the present invention may include, for example, a solvent to lower the viscosity of the formulation further, other resins such as a phenolic resin that can be blended with the epoxy resin of the formulation, other epoxy resins different from the epoxy compound of the present invention (for example, aromatic and aliphatic glycidyl ethers; cycloaliphatic epoxy resins; and divinylarene dioxides such as divinylbenzene dioxide), other curing agents, curing catalyst, fillers, pigments, toughening agents, leveling assistants, flow modifiers, thixotropic agents, adhesion promoters, diluents, stabilizers, plasticizers, catalyst de-activators, flame retardants, and mixtures thereof. For example, the solvent that can be added to the curable composition may be selected from ketones, ethers, aromatic hydrocarbons, glycol ethers, cyclohexanone, and combinations thereof.

Generally, the amount of other optional components, when used in the present invention, may be for example, from 0 wt % to about 90 wt % in one embodiment, from about 0.01 wt % to about 70 wt % in another embodiment; from about 0.1 wt % to about 50 wt % in still another embodiment.

The process for preparing the curable composition of the present invention includes admixing (I) at least one epoxide compound; and (II) at least one phenalkamine compound (III) at least one isocyanate. Optionally, other optional ingredients are added to the curable composition mixture as needed. For example, the preparation of the curable formulation of the present invention is achieved by blending, in known mixing equipment, the epoxy compound, the curing agent composition, and optionally any other desirable additives. Any of the above-mentioned optional additives may be added to the curable composition during the mixing or prior to the mixing to form the curable composition which is to be cured.

In one preferred embodiment of the present invention, the curable composition may be produced by mixing a “Part A” with a “Part B”; wherein Part A may contain the epoxy compound blended with the isocyanate and/or other optional additives; and wherein Part B may generally contain the phenalkamine hardener. In another embodiment, Part B in addition to the phenalkamine hardener may contain an isocyanate and/or other optional additives.

All the compounds of the curable formulation are typically mixed and dispersed at a temperature enabling the preparation of an effective curable epoxy resin composition having the desired balance of properties for a particular application. For example, the temperature during the mixing of all components may be generally from about 5° C. to about 200° C. in one embodiment, and from about 10° C. to about 50° C. in another embodiment. Lower mixing temperatures can be used to help minimize reaction of the epoxide and hardener in the composition and to maximize the pot life of the composition.

The preparation of the curable formulation of the present invention, and/or any of the steps thereof, may be a batch or a continuous process. The mixing equipment used in the process may be any vessel and ancillary equipment well known to those skilled in the art.

The process of the present invention includes curing the curable resin composition to form a thermoset or cured product.

The process of curing of the curable composition may be carried out at a predetermined temperature and for a predetermined period of time sufficient to cure the composition and the curing may be dependent on the hardeners used in the formulation. For example, the temperature of curing the formulation may be generally from about 5° C. to about 200° C.

Generally, the curing time of the curable composition may be chosen between about 1 minute to about 4 hours in one embodiment, between about 5 minutes to about 2 hours in another embodiment, and between about 10 minutes to about 1.5 hours in still another embodiment. Below a period of time of about 1 minute, the time may be too short to ensure sufficient reaction under conventional processing conditions; and above about 4 hours, the time may be too long to be practical or economical.

The present invention discloses a novel synergistic combination of isocyanate and phenalkamine and use of such combination as a curing agent composition to improve the physical properties of cured epoxy resins; and to obtain a cured epoxy resin having the benefit of a balance of properties. The cured product (that is, the cross-linked product made from the curable composition) of the present invention shows several improved properties over conventional epoxy cured resins.

In another embodiment of the present invention, the curing agent composition comprising a combination of isocyanate and phenalkamine can be used to flexibilize the cured product of the present invention. For example, the cured product of the present invention exhibits an elongation of up to about 200% in one embodiment, from about 5% to about 200% in another embodiment, from about 10% to about 100% in still another embodiment, and from about 20% to about 50% in yet another embodiment. The flexibility of the cured product can be measured by the method described in ASTM D522.

In still another embodiment of the present invention, the curing agent composition having the isocyanate compound can be used to toughen the epoxy resin enabled by the phenalkamine. For example, the cured product of the present invention exhibits an impact resistance of from about 9 cm·kg to about 181 cm·kg in one embodiment, from about 12 cm·kg to about 120 cm·kg in another embodiment, and from about 18 cm·kg to about 81 cm·kg in still another embodiment. The toughness of the cured product can be measured by the method described in ASTM G14.

The curable composition of the present invention may be used to manufacture a cured thermoset product. For example, the curable composition may be used in applications including protective coating, civil engineering, water infrastructures industries, and the like.

### EXAMPLES

The following examples and comparative examples further illustrate the present invention in detail but are not to be construed to limit the scope thereof.

Various terms, designations and materials used in the following examples are explained herein below:

DER 671X75 is a solid epoxy resin dissolved in xylene and commercially available from The Dow Chemical Company.

Desmocap-11 is a blocked isocyanate, reactive flexibilizer and commercially available from Bayer.

D.E.H™ 641 is a phenalkamine specialty hardener having an AHEW of 125 g/equivalent and commercially available from The Dow Chemical Company.

DMP30 is a curing accelerator and commercially available from Air Products.

Xylene and N-butanol are solvents and both products are commercially available from SCRC.

Dowanol PM is a solvent and commercially available from The Dow Chemical Company.

### Examples 1-3 and Comparative Example A

The compositions of the epoxy systems used in these examples are described in Table I which include four systems with various concentrations of blocked isocyanate to DER671 w/w in phenalkamine cured epoxy system as indicated in Table I.

TABLE I

| | Comparative | | | |
|---|---|---|---|---|
| | Example 1 | Exam- | Exam- | Exam- |
| | (control) | ple 1 | ple 2 | ple 3 |
| Concentration of blocked | 0 | 10 | 15 | 20 |
| isocyanate (wt %) | | | | |
| Part A | | | | |
| DER671X75 | 100 | 100 | 100 | 100 |
| Desmocap 11 | 0.0 | 11.1 | 17.6 | 25.0 |
| Solvent | | | | |
| Xylene | 22.36 | 26.58 | 29.05 | 31.83 |
| N-butanol | 11.18 | 13.29 | 14.53 | 15.91 |
| Dowanol PM | 22.36 | 26.58 | 29.05 | 31.83 |
| Part B | | | | |
| DEH641 | 27.47 | 28.97 | 29.84 | 30.83 |
| DMP30 | 3 | 3 | 3 | 3 |

Panels were prepared from all four coating systems described in Table I. Performances in applicability, physical property, chemical resistance and anti-corrosive resistance were evaluated using the test methods described in Table II.

TABLE II

| Category | Testing Item (unit) | Test Method |
|---|---|---|
| Applicability | Dry time (hours) | Beck Koller |
| Physical property | Elongation conical mandrel (%) | ASTM D522 |
| | Impact resistance | ASTM G14 |
| | Cupping test (mm) | ISO 1520 |
| | Adhesion | ISO 2409 |
| Anti-corrosive property | Salt spray | ISO 7253 |

The results described in Table III show that brittleness versus fast-dry tradeoff is able to be balanced by addition of blocked isocyanate. When increasing the concentration of blocked isocyanate, elongation, impact resistance and adhesion of the paint is continuously improved. When the content of blocked isocyanate increases to 10%, excellent effects were obtained. Moreover, the salt spray test on a clear coating with a scratch for 200 hours shows that blocked isocyanate shows no negative impact on chemical resistance.

TABLE III

| | Comparative | Exam- | Exam- | Exam- |
|---|---|---|---|---|
| | Example 1 | ple 1 | ple 2 | ple 3 |
| Item | (0%) | (10%) | (15%) | (20%) |
| Dry time (hour) | 1 | 1 | 1 | 1.2 |
| Impact resistance (cm · kg) | 18 | 27 | 82 | >181 |
| Elongation (%) | <4 | <4 | 33 | >33 |
| Cupping (mm) | 0.2 | 2.85 | >6 | >6 |
| Adhesion on stainless steel | 4 | 3-1 | 0 | 0 |
| panel | | | | |

1. A curing agent composition for an epoxy compound comprising: (a) at least one modified cashew nutshell liquid hardener or the phenalkamine; and (b) at least one isocyanate.

2. The curing agent composition of claim 1, wherein the phenalkamine compound comprises a product prepared by a Mannich reaction of cashew nutshell liquid with an aldehyde and a polyamine.

3. The curing agent composition of claim 1, wherein the phenalkamine has a viscosity of from about 10 mPa-s to about 5,000 mPa-s.

4. The curing agent composition of claim 1, wherein the phenalkamine compound comprises a compound defined by Structure (I) as follows: 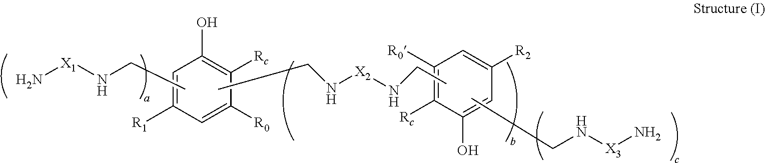
the residue anacardic acid in the distillated cashew nutshell liquid used to produce phenalkamine is less than about 5 percent wherein about 95 percent of the phenalkamine molecules with Structure (I) has R_{c} being hydrogen.

5. The curing agent composition of claim 4, wherein R₀ and R_{0′} each can be a straight alkyl with 15 carbons and 0 to 3 C═C bond(s) selected from the group consisting of —C₁₅H₃₁, —C₁₅H₂₉, —C₁₅H₂₇, and —C₁₅H₂₅, or a straight alkyl with 17 carbons and 1 to 3 C═C bond(s) selected from the group consisting of —C₁₇H₃₃, —C₁₇H₃₁, and —C₁₇H₂₉.

6. The curing agent composition of claim 4, wherein X₁, X₂, and X₃ each can be a bivalent or multivalent group selected from the group consisting of an ethylene aliphatic, an amino ethylene, a polyoxyalkylene, acycloaliphatic, an aromatic, and a polycyclic structure.

7. The curing agent composition of claim 1, wherein the isocyanate comprises an unblocked isocyanate.

8. The curing agent composition of claim 1, wherein the isocyanate comprises a blocked isocyanate.

9. The curing agent composition of claim 8, wherein the blocked isocyanate comprises a compound produced by reacting isocyanate, a polyol and a blocking agent.

10. A curable composition comprising: (I) at least one epoxy compound; (II) at least one phenalkamine, and (III) at least one at least one isocyanate.

11. The curable composition of claim 10, wherein the epoxy compound and the isocyanate are blended to form a first part of the curable composition; and wherein the phenalkamine comprises a second part of the curable composition.

12. The curable composition of claim 10, wherein the epoxide compound comprises a diglycidylether of bisphenol A.

13. The curable composition of claim 10, including a curing catalyst, a second curing agent separate and different from compound (II) and compound (III), a filler, a reactive diluent, a flexibilizing agent, a processing aide, a toughening agent, or a mixture thereof.

14. (canceled)

15. (canceled)

16. (canceled)

17. (canceled)

18. A cured thermoset article comprising the reaction product of: (I) at least one epoxy compound; and (II) at least one phenalkamine, and (III) at least one isocyanate.

19. The cured thermoset article of claim 18 comprising a coating.
